(19) United States
(12) Patent Application Publication
(10) Pub. No.: US 2021/0269665 A1
(43) Pub. Date: Sep. 2, 2021

(54) SELF-STRATIFYING COATING COMPOSITIONS

(71) Applicant: BASF SE, Ludwigshafen am Rhein (DE)

(72) Inventors: Nicolas A. FOLEY, Charlotte, NC (US); Lindsay Michelle JOHNSON, Tarrytown, NY (US)

(21) Appl. No.: 17/185,531

(22) Filed: Feb. 25, 2021

Related U.S. Application Data
(60) Provisional application No. 62/982,204, filed on Feb. 27, 2020.

(51) Int. Cl. C09D 133/08; C09D 125/14; B08B 17/02

(52) U.S. Cl. CPC C09D 133/08; B08B 17/02; C09D 125/14

(57) ABSTRACT

The presently claimed invention provides a coating composition and particularly a coating composition that is self-stratifying or self-layering with the desired performance properties described herein.

### FIELD OF THE DISCLOSURE

The present invention relates to a coating composition. More particularly, the present invention relates to a coating composition that is self-stratifying or self-layering.

### BACKGROUND OF THE INVENTION

There is an increasing sensitivity to environmental issues, including the restrained use of organic solvents, volatile organic compounds (VOCs) and other additives such as coalescent agents due to health concerns. Architectural coatings is an area in which it has become important to restrain the use of such compounds, especially in latex paints and waterborne coating compositions. Most coating applications require a complex and demanding set of physical properties of the coating. Additionally, the properties that are desirable at the applied surface interface are often different from the properties desired at the exposed surface. For example, an architectural coating should adhere well on the ‘bottom’ of the film, and resist scratching on the ‘top’ of the film. These ‘top’ and ‘bottom’ coating properties are often contradictory with respect to desired material performance (e.g. the film should be ‘hard’ on ‘top’ and be ‘soft’ on ‘bottom’). There remains an unmet need for coating compositions that can be prepared with these desired surface-specific properties without the use of crosslinking agents during or after drying under ambient conditions to meet the environmental standards.

In the art, coatings can include multiple layers, formed for example by applying successive coatings to afford multi-layered structures that have tailored properties at different surfaces and interfaces. However, this is a cost- and time-intensive approach that requires multiple coating compositions, and multiple application/drying steps.

A number of fluorinated coating compositions have been recently reported to minimize the number of layers of the coating. In the state of the art, coating compositions for stratification are known and described, for instance, in the following references.

U.S. Pat. No. 9,000,069 B1 describes a coating composition formed by combining two latex resins, wherein the stratifying latex comprises at least one fluorine containing monomer to promote migration of the stratifying latex to the surface of the coating.

U.S. 2004/0127593 A1 describes a self-coating or self-layering from at least two different resins, oligomers, polymers which are emulsifiable or dispersible in water, have different surface tensions and form self-layering phases.

WO 1994/004616 A1 discloses a waterborne coating system comprising a topcoat polymer and a base coat polymer each in dispersion and including a component that results in increased mobility of the topcoat polymer relative to the base coat polymer.

U.S. Pat. No. 8,492,001 B2 describes a self-stratifying coating composition comprising a base layer, a top layer having at least one acrylate and methacrylate selected from the group consisting of fluorinated acrylates and fluorinated methacrylates and a crosslinking agent.

The methods and compositions disclosed in the prior arts have limitations. Application of successive coatings is cost and time intensive and requires multiple coating compositions and multiple application and drying steps. The halogen-containing coating compositions and stratifying coating compositions described in the prior art can be costly and come under significant regulatory scrutiny. The stratifying latex polymer in the compositions described in the prior art comprise at least one driver to promote the migration of the stratifying latex to the surface of the coating during curing or drying. However, such drivers, also referred to as stratifying agents or segregation agents or a stratifying promoting agents are expensive; can limit the coating formulation space; and can affect other final film properties (i.e., film formation). Further, the process of preparing such coating compositions include the use of crosslinking agents that can effectively change the final properties of a coating. Furthermore, there is no known mechanism that shows the resultant physical properties of the coating varying between the ‘top’ and ‘bottom’ of the coating. Therefore, there is a need for an improved coating composition that can self-stratify, for example, form a top layer and a base layer, without the use of additional stratifying agents or layering agents that can negatively impact cost, environmental safety or formulation latitude.

Hence, it is an object of the presently claimed invention to provide a self-stratifying coating composition that overcomes the above-mentioned drawbacks, enriches a specific component at either the top or bottom of the yielded coating and can combine the advantages of targeted properties arranged within the film with the benefit of a single application. Another object of the presently claimed invention is to provide a coating composition that enables improved coating properties to be independently tailored and targeted at the different sides of the film.

### SUMMARY OF THE INVENTION

Surprisingly, it was found that the coating composition disclosed herein comprising a plurality of latex polymer particles comprising a first polymer particle and a second polymer particle that are distinct and different in composition enables self-stratification. Still further, the self-stratifying or the segregating behaviour of the coating compositions provides improved properties such as adhesion, stain resistance, stain blocking, gloss and pendulum hardness.

Accordingly, in one aspect, the presently claimed invention is directed to a coating composition having a plurality of latex polymer particles. The plurality of latex polymer particles includes a first polymer particle having a first volume average particle size diameter in the range of from about 20 nm to about 1,000 nm, determined according to dynamic light scattering method. The plurality of latex polymer particles also includes a second polymer particle having a second volume average particle size diameter in the range of from about 5 nm to about 250 nm, determined according to dynamic light scattering method. The ratio of the second volume average particle size diameter to the first volume average particle size diameter is in the range of from about 1:20 to about 1:4, and at least one of the first polymer particle and the second polymer particle have one or more ethylenically unsaturated monomers.

In accordance with another aspect of the presently claimed invention, a film is provided that is derived from a coating composition described herein, wherein the film comprises a first surface and a second surface opposite the first surface. After application of the coating composition to a substrate and subsequent drying, these surfaces will have different physical compositions and potentially different film properties.

### BRIEF DESCRIPTION OF THE DRAWINGS

In order to provide an understanding of embodiments of the invention, reference is made to the appended drawings, which are not necessarily drawn to scale, and in which reference numerals refer to components of exemplary embodiments of the invention. The drawings are exemplary only and should not be construed as limiting the invention. The above and other features of the presently claimed invention, their nature, and various advantages will become more apparent upon consideration of the following detailed description, taken in conjunction with the accompanying drawings:

FIG. 1 relative to Example 2 illustrates the ATR-FTIR spectra of both the top and bottom sides of an ambient dried film formed in the carbonyl stretch region comprised of contributions from both the first latex polymer and the second latex polymer that was measured from about 1800 cm⁻¹ to about 1650 cm⁻¹ and compared against styrene C—H bend at 720 cm⁻¹ to 680 cm⁻¹. The relative concentrations of the first and second polymer are then compared to yield a surface enrichment.

### DETAILED DESCRIPTION OF THE INVENTION

The presently claimed invention is not to be limited in terms of the embodiments described in this application. Modifications and variations can be made without departing from its spirit and scope, as will be apparent to those skilled in the art. Functionally equivalent methods, formulations, and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to methods, reagents, compounds, or compositions, which can, of course, vary. It is also to be understood that the terminology used herein is for the purpose of describing embodiments only and is not intended to be limiting.

Furthermore, the terms “(a)”, “(b)”, “(c)”, “(d)” etc. and the like in the description and in the claims, are used for distinguishing between similar elements and not necessarily for describing a sequential or chronological order. It is to be understood that the terms so used are interchangeable under appropriate circumstances and that the embodiments of the subject matter described herein are capable of operation in other sequences than described or illustrated herein. In case the terms “(A)”, “(B)” and “(C)” or “(a)”, “(b)”, “(c)”, “(d)”, “(i)”, “(ii)” etc. relate to steps of a method or use or assay there is no time or time interval coherence between the steps, that is, the steps may be carried out simultaneously or there may be time intervals of seconds, minutes, hours, days, weeks, months or even years between such steps, unless otherwise indicated in the application as set forth herein above or below.

For the purposes of the presently claimed invention, where features or aspects of the disclosure are described in terms of Markush groups, those skilled in the art will recognize that the disclosure is also thereby described in terms of any individual member or subgroup of members of the Markush group.

For the purposes of the presently claimed invention, all ranges disclosed herein also encompass any and all possible subranges and combinations of subranges thereof. The ranges defined throughout the specification include the end values as well, i.e. a range of 1 to 10 implies that both 1 and 10 are included in the range. For the avoidance of doubt, the applicant shall be entitled to any equivalents according to applicable law. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

The use of the terms “a”, “an”, “the”, and similar referents in the context of describing the materials and methods discussed herein (especially in the context of the following claims) are to be construed to cover both the singular and the plural, unless otherwise indicated herein or clearly contradicted by context.

The term “about” used throughout this specification is used to describe and account for small fluctuations. For example, the term “about” refers to less than or equal to ±5%, such as less than or equal to ±2%, less than or equal to ±1%, less than or equal to ±0.5%, less than or equal to ±0.2%, less than or equal to ±0.1% or less than or equal to ±0.05%. All numeric values herein are modified by the term “about,” whether explicitly indicated. A value modified by the term “about” of course includes the specific value. For instance, “about 5.0” or “about 5” must include 5.0 or 5.

In the following passages, different aspects of the subject matter are defined in more detail. Each aspect so defined may be combined with any other aspect or aspects unless clearly indicated to the contrary. Any feature indicated as being preferred or advantageous may be combined with any other feature or features indicated as being preferred or advantageous.

Reference throughout this specification to “one embodiment” or “an embodiment” means that a feature, structure or characteristic described in connection with the embodiment is included in at least one embodiment of the presently claimed invention. Thus, appearances of the phrases “in one embodiment” or “in an embodiment” in various places throughout this specification are not necessarily all referring to the same embodiment but may refer. Furthermore, the features, structures or characteristics may be combined in any suitable manner, as would be apparent to a person skilled in the art from this disclosure, in one or more embodiments. Furthermore, while some embodiments described herein include some, but not other features included in other embodiments, combinations of features of different embodiments are meant to be within the scope of the subject matter, and form different embodiments, as would be understood by those in the art. For example, in the appended claims, any of the claimed embodiments can be used in any combination.

Although the embodiments disclosed herein have been described with reference to embodiments it is to be understood that these embodiments are merely illustrative of the principles and applications of the presently claimed invention. It will be apparent to those skilled in the art that various modifications and variations can be made to the methods and apparatus of the presently claimed invention without departing from the spirit and scope of the presently claimed invention. Thus, it is intended that the presently claimed invention include modifications and variations that are within the scope of the appended claims and their equivalents, and the above-described embodiments are presented for purposes of illustration and not of limitation. All patents and publications cited herein are incorporated by reference herein for the specific teachings thereof as noted, unless other statements of incorporation are specifically provided.

All methods described herein can be performed in any suitable order unless otherwise indicated herein or otherwise clearly contradicted by context. The use of any and all examples, or exemplary language (e.g., “such as”) provided herein, is intended merely to better illustrate the materials and methods and does not pose a limitation on the scope unless otherwise claimed.

For the purposes of the presently claimed invention, “latex polymer” or “latex polymer particles” are defined as a stable dispersion of polymer particles in an aqueous medium.

For the purposes of the presently claimed invention, the term “polymer” refers to a single polymer or a mixture of polymers which comes about in a formation reaction from monomers to give macromolecules.

For the purposes of the presently claimed invention, the term “aqueous” or “water-borne” as used herein refers to the presence of a significant fraction of water as the main continuous medium besides organic solvents or 100 percentage content of water. Within the continuous water phase exists dissolved polymers that create a homogenous solution with both the polymer and water as the continuous medium or as a dispersed emulsion of the polymers in water that create a heterogenous solution with water as the continuous medium.

The use of (meth) in a monomer or repeat unit indicates an optional methyl group. The term “copolymer” means that the copolymer comprises a mixture of two or more monomers that are assembled into a copolymer that adopts a block, statistical, or random copolymer structure. The term “homopolymer” is defined as a polymer where every monomer unit of the chain is same.

For the purposes of the presently claimed invention, the term “self-stratifying” or “self-layering” refers to a coating that contains at least two polymers of different compositions which stratify after application onto a substrate and subsequent drying.

For the purposes of the presently claimed invention, the term “segregation agent” or “segregation promoting agent” or “stratifying promoting agent” or “phase-separating agent” refers to at least one driver in the coating compositions that promotes the migration of the stratifying latex to the surface of the coating during curing or drying.

For the purposes of the presently claimed invention, the terms “first surface” and “second surface” refers to the “bottom surface” and “top surface” respectively of the substrate coated or a film and are interchangeably used herein.

For the purposes of the presently claimed invention, “theoretical glass transition temperature” or “theoretical Tg” refers to estimated Tg of a polymer or a copolymer calculated using the Fox equation. The Fox equation can be used to estimate the glass transition temperature of a polymer or copolymer as described, for example, in L. H. Sperling, “Introduction to Physical Polymer Science”, 2nd Edition, John Wiley & Sons, New York, p. 357 (1992) and T. G. Fox, Bull. Am. Phys. Soc, 1, 123 (1956), both of which are incorporated herein by reference. For example, the theoretical glass transition temperature of a copolymer derived from monomers a, b, . . . , and i can be calculated according to the equation below, where wₐ is the weight fraction of monomer a in the copolymer, T_{ga} is the glass transition temperature of a homopolymer of monomer a, w is the weight fraction of monomer b in the copolymer, T_{gb} is the glass transition temperature of a homopolymer of monomer b, wᵢ is the weight fraction of monomer i in the copolymer, T_{gi} is the glass transition temperature of a homopolymer of monomer i, and Tg is the theoretical glass transition temperature of the copolymer derived from monomers a, b, . . . , and i.

$$\frac{1}{{T}_{g}} = \frac{{w}_{a}}{{T}_{g a}} + \frac{{w}_{b}}{{T}_{g b}} + \text{...} + \frac{{w}_{i}}{{T}_{g i}}$$

The term ‘% by weight’ or ‘wt. %’ as used in the presently claimed invention is with respect to the total weight of the composition. Further, the sum of wt.-% of all the compounds, as described hereinbelow, in the respective component adds up to 100 wt.-%.

For the purposes of the presently claimed invention, the mass-average (Mw) and number-average (Mn) molecular weight are determined by means of gel permeation chromatography at 40° C., using a high-performance liquid chromatography pump and a refractive index detector. The eluent used was tetrahydrofuran with an elution rate of 1 ml/min. The calibration is carried out by means of polystyrene standards.

The above-mentioned measurement techniques are well known to a person skilled in the art and therefore do not limit the presently claimed invention.

The term “substituted” refers to an organic group as defined below (e.g., an alkyl group) in which one or more bonds to a hydrogen atom contained therein are replaced by a bond to non-hydrogen or non-carbon atoms. Substituted groups also include groups in which one or more bonds to a carbon(s) or hydrogen(s) atom are replaced by one or more bonds, including double or triple bonds, to a heteroatom. Thus, a substituted group will be substituted with one or more substituents, unless otherwise specified. In some embodiments, a substituted group is substituted with 1, 2, 3, 4, 5, or 6 substituents. Examples of substituent groups include: halogens (i.e., F, Cl, Br, and I); hydroxyls; alkoxy, alkenoxy, alkynoxy, aryloxy, aralkyloxy, heterocyclyloxy, and heterocyclylalkoxy groups; carbonyls (oxo); carboxyls; esters; ethers; urethanes; hydroxylamines; alkoxyamines; aralkoxyamines; thiols; sulfides; sulfoxides; sulfones; sulfonyls; sulfonamides; amines; N-oxides; hydrazines; hydrazides; hydrazones; azides; amides; ureas; enamines; imides; isocyanates; isothiocyanates; cyanates; thiocyanates; imines; nitro groups; nitriles (i.e., CN); and the like.

An aspect of the presently claimed invention relates to a coating composition comprising:

a plurality of latex polymer particles, comprising,
i) a first polymer particle having a first volume average particle size diameter in the range of from about 20 nm to about 1,000 nm, determined according to dynamic light scattering method; and
ii) a second polymer particle having a second volume average particle size diameter in the range of from about 5 nm to about 250 nm, determined according to dynamic light scattering method;
wherein the ratio of the second volume average particle size diameter to the first volume average particle size diameter is in the range of from about 1:20 to about 1:4, and
wherein at least one of the first polymer particle and the second polymer particle comprise one or more ethylenically unsaturated monomers.

In an embodiment of the presently claimed invention, the first volume average particle size diameter is in the range of from about 20 nm to about 1000 nm, determined according to dynamic light scattering method. In an embodiment of the presently claimed invention, the first volume average particle size diameter is in the range of from about 20 nm to about 1000 nm, or from about 50 nm to about 750 nm, or from about 150 nm to about 500 nm, determined according to dynamic light scattering method. In some embodiments, the first volume average particle size diameter is less than 1000 nm, for example, less than 950 nm, less than 900 nm, less than 850 nm, less than 800 nm, less than 750 nm, less than 700 nm, less than 650 nm, less than 600 nm, less than 550 nm, less than 500 nm, less than 450 nm, less than 400 nm, determined according to dynamic light scattering method. In some embodiments, the first volume average particle size diameter is at least 20 nm, for example, at least 25 nm, at least 30 nm, at least 35 nm, at least 40 nm, at least 45 nm, at least 50 nm, at least 55 nm, at least 60 nm, at least 65 nm, at least 70 nm, at least 75 nm, at least 80 nm, at least 85 nm, at least 90 nm, at least 95 nm, at least 100 nm, at least 120 nm, at least 150 nm, at least 200 nm, determined according to dynamic light scattering method. The first volume average particle size diameter of the first polymer particle can range from any of the minimum values described above to any of the maximum values described above, for example, 20 nm to 1000 nm, 50 nm to 900 nm, 50 nm to 800 nm, 50 nm to 750 nm, 75 nm to 750 nm, 100 nm to 750 nm, 150 nm to 750 nm, 150 nm to 500 nm, 150 nm to 400 nm, in each determined according to dynamic light scattering method.

In an embodiment of the presently claimed invention, the first polymer particle has a theoretical glass transition temperature in the range of from about −70° C. to about 50° C. measured using differential scanning calorimetry (DSC). In an embodiment of the presently claimed invention, the first polymer particle has a theoretical glass transition temperature in the range of from about −70° C. to about 50° C., or from about −10° C. to about 25° C., measured using differential scanning calorimetry (DSC). In some embodiments, the first polymer particle has a theoretical glass transition temperature can be 50° C. or less, for e.g. 45° C. or less, 40° C. or less, 35° C. or less, 30° C. or less, 25° C. or less, 20° C. or less, 15° C. or less, 10° C. or less, measured using differential scanning calorimetry (DSC). In some embodiments, the first polymer particle has a theoretical glass transition temperature can be at least −70° C., for e.g. at least −65° C., at least −60° C., at least −−55° C., at least −50° C., at least −45° C., at least −40° C., at least −35° C., at least −30° C., at least −25° C., at least −20° C., at least −15° C., at least −10° C., measured using differential scanning calorimetry (DSC). The theoretical glass transition temperature of the first polymer particle can range from any of the minimum values described above to any of the maximum values described above.

In an embodiment of the presently claimed invention, the first polymer particle has a number average molecular weight in the range of from about 15,000 Da to about 500,000 Da, determined according to gel permeation chromatography. In some embodiments, the first polymer particle has a number average molecular weight of less than 500,000 Da, for e.g., less than 450,000 Da, less than 400,000 Da, less than 350,000 Da, less than 300,000 Da, less than 250,000 Da, less than 200,000 Da, less than 150,000 Da, less than 100,000 Da, determined according to gel permeation chromatography. In some embodiments, the first polymer particle has a number average molecular weight of at least 15,000 Da, for e.g., at least 20,000 Da, at least 25,000 Da, at least 30,000 Da, at least 35,000 Da, at least 40,000 Da, at least 45,000 Da. at least 50,000 Da, at least 55,000 Da, at least 60,000 Da, at least 65,000 Da, at least 100,000 Da, at least 120,000 Da, at least 150,000 Da, at least 200,000 Da, at least 300,000 Da, determined according to gel permeation chromatography. The number average molecular weight of the first polymer particle can range from any of the minimum values described above to any of the maximum values described above.

In an embodiment of the presently claimed invention, the first polymer particle and the second polymer particle comprise plurality of copolymers derived from one or more ethylenically-unsaturated monomers.

In an embodiment of the presently claimed invention, the first polymer particle comprises a polymer selected from the group of acrylic homopolymers, acrylic-based copolymers, styrene-acrylic-based copolymers, styrene-butadiene-based copolymers, styrene-butadiene-styrene block copolymers, vinyl acrylic-based copolymers, ethylene vinyl acetate based copolymers, alkyd resin, polyester resins, polyurethane resins, silicone resins, petroleum resins, epoxy resins, and blends thereof. In another embodiment of the presently claimed invention, the first polymer particle comprises a polymer selected from the group of acrylic homopolymers, acrylic-based copolymers, styrene-acrylic-based copolymers, and blends thereof.

In another embodiment of the presently claimed invention, the first polymer particle can include an (meth) acrylic-based copolymer or homopolymer. In yet another embodiment of the presently claimed invention, the first polymer particle can include styrene-acrylic-based copolymers.

For the purposes of the presently claimed invention, (meth) acrylic-based copolymers include but are not limited to copolymers derived from one or more (meth)acrylate monomers. The acrylic based copolymer can be a pure acrylic polymer, a styrene-acrylic polymer or a vinyl acrylic polymer.

In an embodiment of the presently claimed invention, the first polymer particle can be derived from at least 40 wt. % of one or more ethylenically-unsaturated monomers, based on the total weight of the monomers used to form the first polymer particle.

For the purposes of the presently claimed invention, the first polymer particle can be derived from at least 40 wt. % for e.g., at least 45 wt. %, at least 50 wt. %, at least 55 wt. %, at least 60 wt. %, at least 65 wt. %, at least 70 wt. %, at least 75 wt. %, at least 80 wt. %, at least 85 wt. %, at least 90 wt. %, at least 95 wt. %, of one or more ethylenically-unsaturated monomers. For the purposes of the presently claimed invention, the first polymer particle can be derived from at most 95 wt. % for e.g., at most 90 wt. %, at most 85 wt. %, at most 80 wt. %, at most 75 wt. %, at most 70 wt. %, at most 65 wt. %, at most 60 wt. %, at most 55 wt. %, at most 50 wt. %, at most 45 wt. %, at most 40 wt. %, of one or more ethylenically-unsaturated monomers. The first polymer particle can be derived from an amount of one or more ethylenically-unsaturated monomers ranging from any of the minimum percentages of weight to any of the maximum percentages by weight described above.

In an embodiment of the presently claimed invention, the first polymer particle can be derived from at least 40 wt. % of one or more (meth) acrylate monomers, based on the total weight of the monomers used to form the first polymer particle, for e.g., at least 40% by weight, at least 45% by weight, at least 50% by weight, at least 55% by weight, at least 60% by weight, at least 65% by weight, at least 70% by weight, at least 75% by weight, at least 80% by weight, at least 85% by weight, at least 90% by weight, or at least 95% by weight, based on the total weight of the monomers used to form the first polymer particle. The (meth)acrylate monomer can include esters of α,β-monoethylenically unsaturated monocarboxylic and dicarboxylic acids having 3 to 6 carbon atoms with alkanols having 1 to 12 carbon atoms, for e.g., esters of acrylic acid, methacrylic acid, maleic acid, fumaric acid, or itaconic acid, with C₁-C₂₀, C₁-C₁₂, C₁-C₈, or C₁-C₄ alkanols.

Exemplary acrylate and methacrylate monomers include, but are not limited to, methyl acrylate, methyl methacrylate, ethyl acrylate, ethyl methacrylate, butyl acrylate, butyl methacrylate, 2-ethylhexyl acrylate, 2-ethylhexyl methacrylate, isobutyl (meth)acrylate, n-hexyl (meth)acrylate, n-heptyl (meth)acrylate, 2-methylheptyl (meth)acrylate, octyl (meth)acrylate, isooctyl (meth)acrylate, n-nonyl (meth)acrylate, isononyl (meth)acrylate, n-decyl (meth)acrylate, isodecyl (meth)acrylate, dodecyl (meth)acrylate, lauryl (meth)acrylate, tridecyl (meth)acrylate, stearyl (meth)acrylate, glycidyl (meth)acrylate, alkyl crotonates, vinyl acetate, di-n-butyl maleate, di-octylmaleate, hydroxyethyl (meth)acrylate, allyl (meth)acrylate, tetrahydrofurfuryl (meth)acrylate, cyclohexyl (meth)acrylate, 2-ethoxyethyl (meth)acrylate, 2-methoxy (meth)acrylate, 2-(2-ethoxyethoxy)ethyl (meth)acrylate, 2-propylheptyl (meth)acrylate, 2-phenoxyethyl (meth)acrylate, isobornyl (meth)acrylate, caprolactone (meth)acrylate, polypropyleneglycol mono(meth)acrylate, polyethyleneglycol (meth)acrylate, benzyl (meth)acrylate, hydroxypropyl (meth)acrylate, methylpolyglycol (meth)acrylate, 3,4-epoxycyclohexylmethyl (meth) acrylate, 1,6 hexanediol di(meth)acrylate, 1,4 butanediol di(meth)acrylate, and combinations thereof. In some embodiments, the first polymer particle is derived from one or more (meth)acrylate monomers selected from the group of methyl methacrylate, butyl acrylate, 2-ethylhexylacrylate, and combinations thereof. In some embodiments, the first polymer particle is derived from methyl methacrylate and butyl acrylate.

The first polymer particle can be derived from one or more carboxylic acid-containing monomers based on the total weight of monomers forming the first polymer particle. Suitable carboxylic acid-containing monomers are known in the art, and include α,β-monoethylenically unsaturated mono- and dicarboxylic acids, such as acrylic acid, methacrylic acid, itaconic acid, crotonic acid, maleic acid, fumaric acid, dimethacrylic acid, ethylacrylic acid, allylacetic acid, vinylacetic acid, mesaconic acid, methylenemalonic acid, citraconic acid, and combinations thereof.

The first polymer particle can be derived from at least 40 wt. % of one or more additional ethylenically-unsaturated monomers. For example, the first polymer particle can further include a vinyl aromatic having up to 20 carbon atoms, a vinyl ester of a carboxylic acid comprising up to 20 carbon atoms, a (meth)acrylonitrile, a vinyl halide, a vinyl ether of an alcohol comprising 1 to 10 carbon atoms, an aliphatic hydrocarbon having 2 to 8 carbon atoms and one or two double bonds, a silane-containing monomer, a (meth)acrylamide, a (meth)acrylamide derivative, a sulfur-based monomer, or a combination of these monomers.

Suitable vinyl aromatic compounds include styrene, α- and β-methylstyrene, α-butylstyrene, 4-n-butylstyrene, 4-n-decylstyrene, vinyltoluene, and combinations thereof. Vinyl esters of carboxylic acids comprising up to 20 carbon atoms include, for example, vinyl laurate, vinyl stearate, vinyl propionate, versatic acid vinyl esters, vinyl acetate, and combinations thereof. The vinyl halides can include ethylenically unsaturated compounds substituted by chlorine, fluorine or bromine, such as vinyl chloride and vinylidene chloride. The vinyl ethers can include, for example, vinyl ethers of alcohols comprising 1 to 4 carbon atoms, such as vinyl methyl ether or vinyl isobutyl ether. Aliphatic hydrocarbons having 2 to 8 carbon atoms and one or two double bonds can include, for example, hydrocarbons having 4 to 8 carbon atoms and two olefinic double bonds, such as butadiene, isoprene, and chloroprene. Silane containing monomers can include, for example, vinyl silanes, such as vinyltrimethoxysilane, vinyltriethoxysilane (VTEO), vinyl tris(2-methoxyethoxysilane), and vinyl triisopropoxysilane, and (meth)acrylatoalkoxysilanes, such as (meth)acryloyloxypropyltrimethoxysilane, γ-(meth)acryloxypropyltrimethoxysilane, and γ-(meth)acryloxypropyltriethoxysilane.

In an embodiment of the presently claimed invention, the second volume average particle size diameter is in the range of from about 10 nm to about 200 nm, determined according to dynamic light scattering method. In an embodiment of the presently claimed invention, the second volume average particle size diameter is in the range of from about 10 nm to about 200 nm, or from about 10 nm to about 150 nm, determined according to dynamic light scattering method. In some embodiments, the second volume average particle size diameter is less than 200 nm, for example, less than 190 nm, less than 180 nm, less than 170 nm, less than 160 nm, less than 150 nm, less than 140 nm, less than 130 nm, less than 120 nm, less than 100 nm, less than 90 nm, less than 80 nm, less than 60 nm, determined according to dynamic light scattering method. In some embodiments, the second volume average particle size diameter is at least 10 nm, for example, at least 12 nm. at least 15 nm, at least 20 nm, at least 25 nm, at least 30 nm, at least 35 nm, at least 40 nm, determined according to dynamic light scattering method. The second volume average particle size diameter can range from any of the minimum values described above to any of the maximum values described above, for example, from 10 nm to 200 nm, from 12 nm to 200 nm, from 15 nm to 180 nm, from 15 nm to 160 nm, from 15 nm to 150 nm, from 20 nm to 200 nm, from 20 nm to 150 nm, from 10 nm to 150 nm, from 10 nm to 100 nm, in each determined according to dynamic light scattering method.

In an embodiment of the presently claimed invention, the second polymer particle has a theoretical glass transition temperature in the range of from about −20° C. to about 140° C., measured using differential scanning calorimetry (DSC). In an embodiment of the presently claimed invention, the second polymer particle has a theoretical glass transition temperature in the range of from about −20° C. to about 140° C., or from about 0° C. to about 140° C., or from about 20° C. to about 130° C., measured using differential scanning calorimetry (DSC). In some embodiments, the second polymer particle has a theoretical glass transition temperature can be 140° C. or less, for e.g. 135° C. or less, 130° C. or less, 125° C. or less, 120° C. or less, 115° C. or less, 100° C. or less, 95° C. or less, 80° C. or less, measured using differential scanning calorimetry (DSC). In some embodiments, the first polymer particle has a theoretical glass transition temperature can be at least −20° C., for e.g. at least −18° C., at least −15° C., at least −10° C., at least −5° C., at least 0° C., at least 5° C., at least 10° C., at least 15° C., at least 20° C., measured using differential scanning calorimetry (DSC). The theoretical glass transition temperature of the second polymer particle can range from any of the minimum values described above to any of the maximum values described above.

In an embodiment of the presently claimed invention, the second polymer particle has a number average molecular weight in the range of from about 1000 Da to about 200,000 Da, determined according to gel permeation chromatography. In some embodiments, the second polymer particle has a number average molecular weight of less than 200,000 Da, for e.g., less than 150,000 Da, less than 100,000 Da, less than 75,000 Da, less than 50,000 Da less than 45,000 Da, less than 40,000 Da, less than 35,000 Da, less than 30,000 Da, less than 25,000 Da, less than 20,000 Da, less than 15,000 Da, less than 10,000 Da, determined according to gel permeation chromatography. In some embodiments, the second polymer particle has a number average molecular weight of at least 1000 Da, for e.g., at least 1200 Da, at least 1500 Da, at least 2000 Da, at least 2500 Da, at least 3000 Da, at least 4000 Da. at least 4500 Da, at least 5000 Da, at least 6000 Da, at least 7000 Da, at least 8000 Da, at least 9000 Da, at least 10,000 Da, determined according to gel permeation chromatography. The number average molecular weight of the second polymer particle can range from any of the minimum values described above to any of the maximum values described above.

In an embodiment of the presently claimed invention, the second polymer particle comprises a polymer selected from the group of acrylic homopolymers, acrylic-based copolymers, styrene-acrylic-based copolymers, styrene-butadiene-based copolymers, styrene-butadiene-styrene block copolymers, vinyl acrylic-based copolymers, ethylene vinyl acetate-based copolymers, alkyd resin, polyester resins, polyurethane resins, silicone resins, petroleum resins, epoxy resins, and blends thereof. In another embodiment of the presently claimed invention, the second polymer particle comprises a polymer selected from the group of acrylic homopolymers, acrylic-based copolymers, styrene-acrylic-based copolymers, and blends thereof.

In another embodiment of the presently claimed invention, the second polymer particle can include an (meth) acrylic-based copolymer or homopolymer. In yet another embodiment of the presently claimed invention, the second polymer particle can include styrene-acrylic-based copolymers.

For the purposes of the presently claimed invention, (meth) acrylic based copolymers include but are not limited to copolymers derived from one or more (meth)acrylate monomers. The (meth) acrylic-based copolymer can be a pure acrylic polymer, a styrene-acrylic polymer or a vinyl acrylic polymer.

In yet another embodiment of the presently claimed invention, the second polymer particle can be derived from at least 5 wt. % of one or more ethylenically-unsaturated monomers, based on the total weight of the monomers used to form the second polymer particle.

For the purposes of the presently claimed invention, the second polymer particle can be derived from at least 5 wt. % for e.g., at least 10 wt. %, at least 15 wt. %, at least 20 wt. %, at least 25 wt. %, at least 30 wt. %, at least 35 wt. %, at least 40 wt. %, at least 45 wt. %, at least 50 wt. %, at least 55 wt. %, of one or more ethylenically-unsaturated monomers. For the purposes of the presently claimed invention, the second polymer particle can be derived from at most 55 wt. % for e.g., at most 50 wt. %, at most 45 wt. %, at most 40 wt. %, at most 35 wt. %, at most 30 wt. %, at most 25 wt. %, at most 20 wt. %, at most 15 wt. %, at most 10 wt. %, at most 5 wt. %, of one or more ethylenically-unsaturated monomers. The second polymer particle can be derived from an amount of one or more ethylenically-unsaturated monomers ranging from any of the minimum percentages of weight to any of the maximum percentages by weight described above.

In an embodiment of the presently claimed invention, the second polymer particle can be derived from at least 5 wt. % of one or more (meth)acrylate monomers, based on the total weight of the monomers used to form the second polymer particle. Exemplary acrylate and methacrylate monomers include, but are not limited to, methyl acrylate, methyl methacrylate, ethyl acrylate, ethyl methacrylate, butyl acrylate, butyl methacrylate, 2-ethylhexyl acrylate, 2-ethylhexyl methacrylate, isobutyl (meth)acrylate, n-hexyl (meth)acrylate, n-heptyl (meth)acrylate, 2-methylheptyl (meth)acrylate, octyl (meth)acrylate, isooctyl (meth)acrylate, n-nonyl (meth)acrylate, isononyl (meth)acrylate, n-decyl (meth)acrylate, isodecyl (meth)acrylate, dodecyl (meth)acrylate, lauryl (meth)acrylate, tridecyl (meth)acrylate, stearyl (meth)acrylate, glycidyl (meth)acrylate, alkyl crotonates, vinyl acetate, di-n-butyl maleate, di-octylmaleate, hydroxyethyl (meth)acrylate, allyl (meth)acrylate, tetrahydrofurfuryl (meth)acrylate, cyclohexyl (meth)acrylate, 2-ethoxyethyl (meth)acrylate, 2-methoxy (meth)acrylate, 2-(2-ethoxyethoxy)ethyl (meth)acrylate, 2-propylheptyl (meth)acrylate, 2-phenoxyethyl (meth)acrylate, isobornyl (meth)acrylate, caprolactone (meth)acrylate, polypropyleneglycol mono(meth)acrylate, polyethyleneglycol (meth)acrylate, benzyl (meth)acrylate, hydroxypropyl (meth)acrylate, methylpolyglycol (meth)acrylate, 3,4-epoxycyclohexylmethyl (meth) acrylate, 1,6 hexanediol di(meth)acrylate, 1,4 butanediol di(meth)acrylate, and combinations thereof. In some embodiments, the first polymer particle is derived from one or more (meth)acrylate monomers selected from the group of methyl methacrylate, butyl acrylate, 2-ethylhexylacrylate, and combinations thereof. In some embodiments, the first polymer particle is derived from methyl methacrylate and butyl acrylate.

The second polymer particle can be derived from greater than 0% by weight to 50% by weight of one or more additional ethylenically-unsaturated monomers. For example, the second polymer particle can further include a vinyl aromatic having up to 20 carbon atoms, a vinyl ester of a carboxylic acid comprising up to 20 carbon atoms, a (meth)acrylonitrile, a vinyl ether of an alcohol comprising 1 to 10 carbon atoms, an aliphatic hydrocarbon having 2 to 8 carbon atoms and one or two double bonds, a silane-containing monomer, a (meth)acrylamide, a (meth)acrylamide derivative, a sulfur-based monomer, or a combination of these monomers.

Suitable vinyl aromatic compounds include styrene, α- and p-methylstyrene, α-butylstyrene, 4-n-butylstyrene, 4-n-decylstyrene, vinyltoluene, and combinations thereof. Vinyl esters of carboxylic acids comprising up to 20 carbon atoms include, for example, vinyl laurate, vinyl stearate, vinyl propionate, versatic acid vinyl esters, vinyl acetate, and combinations thereof. The vinyl ethers can include, for example, vinyl ethers of alcohols comprising 1 to 4 carbon atoms, such as vinyl methyl ether or vinyl isobutyl ether. Aliphatic hydrocarbons having 2 to 8 carbon atoms and one or two double bonds can include, for example, hydrocarbons having 4 to 8 carbon atoms and two olefinic double bonds, such as butadiene, isoprene, and chloroprene. Silane containing monomers can include, for example, vinyl silanes, such as vinyltrimethoxysilane, vinyltriethoxysilane (VTEO), vinyl tris(2-methoxyethoxysilane), and vinyl triisopropoxysilane, and (meth)acrylatoalkoxysilanes, such as (meth)acryloyloxypropyltrimethoxysilane, γ-(meth)acryloxypropyltrimethoxysilane, and γ-(meth)acryloxypropyltriethoxysilane.

In an embodiment of the presently claimed invention, the ratio of the second volume average particle size diameter to the first volume average particle size diameter is in the range of from about 1:20 to about 1:4. In an embodiment of the presently claimed invention, the ratio of the second volume average particle size diameter to the first volume average particle size diameter is in the range of from about 1:20 to about 1:4, or from about 1:10 to about 1:5. In some embodiments of the presently claimed invention, the ratio of the second volume average particle size diameter to the first volume average particle size diameter can be less than 1:20, for example, less than 1:19, less than 1:18, less than 1:17, less than 1:16, less than 1:15, less than 1:14, less than 1:12, less than 1:11, less than 1:9, less than 1:8, less than 1:7, less than 1:6. In some embodiments of the presently claimed invention, the ratio of the second volume average particle size diameter to the first volume average particle size diameter can be at least 1:4, for example, at least 1:5, at least 1:6, at least 1:7, at least 1:8, at least 1:9, at least at least 1:10, at least 1:11, at least 1:12, at least 1:13, at least 1:14, at least 1:15. The ratio of the second volume average particle size diameter to the first volume average particle size diameter can range from any of the minimum ratios described above to any of the maximum ratios described above.

In an embodiment of the presently claimed invention, the weight ratio of the second polymer particle to the first polymer particle is in the range of from about 1:100 to about 100:1. In an embodiment of the presently claimed invention, the weight ratio of the second polymer particle to the first polymer particle is in the range of from about 1:50 to about 50:1, or from about 1:20 to about 20:1, or from about 1:10 to about 10:1. In an embodiment of the presently claimed invention, the weight ratio of the second polymer particle to the first polymer particle is in the range of from about 1:50 to about 50:1. In some embodiments of the presently claimed invention, the weight ratio of the second polymer particle to the first polymer particle is in the range of from about 1:45 to about 45:1, or from about 1:40 to about 40:1, or from about 1:35 to about 35:1, or from about 1:30 to about 30:1, or from about 1:25 to about 25:1, or from about 1:20 to about 20:1, or from about 1:15 to about 15:1, or from about 1:10 to about 10:1, or from about 1:5 to about 5:1, or from about 1:2 to about 2:1. In some embodiments of the presently claimed invention, the weight ratio of the second polymer particle to the first polymer particle is less than 1:50, for example, less than 1:45, less than 1:40, less than 1:35, less than 1:30, less than 1:25, less than 1:20, less than 1:15, less than 1:10, less than 1:5, less than 1:3, less than 1:2. In some embodiments of the presently claimed invention, the weight ratio of the second polymer particle to the first polymer particle is at least 50:1, for example, at least 45:1, at least 40:1, at least 35:1, at least 30:1, at least 25:1, at least 20:1, at least 15:1, at least 10:1, at least 5:1, at least 4:1, at least 3:1, at least 2:1, at least 1:1. The ratio of the weight ratio of the second polymer particle to the first polymer particle can range from any of the minimum ratios described above to any of the maximum ratios described above.

In an embodiment of the presently claimed invention, the total weight of the first polymer particle and the second polymer particle present in the coating composition is in an amount in the range of from about 2.5 wt. % to about 70 wt. %, based on the total weight of the coating composition. In an embodiment of the presently claimed invention, the total weight of the first polymer particle and the second polymer particle present in the coating composition is in an amount in the range of from about 2.5 wt. % to about 70 wt. %, or from about 5 wt. % to about 70 wt. %, or from about 10 wt. % to about 60 wt. %, or from about 10 wt. % to about 50 wt. %, or from about 10 wt. % to about 40 wt. %, based on the total weight of the coating composition. In an embodiment of the presently claimed invention, the total weight of the first polymer particle and the second polymer particle present in the coating composition is in an amount in the range of from about 2.5 wt. % to about 70 wt. %. In some embodiments of the presently claimed invention, the total weight of the first polymer particle and the second polymer particle present in the coating composition is at least 2.5 wt. %, for example, at least 3 wt. %, at least 3.5 wt. %, at least 4 wt. %, at least 4.5 wt. %, at least 5 wt. %, at least 5.5 wt. %, at least 6 wt. %, at least 6.5 wt. %, at least 7 wt. %, at least 7.5 wt. %, at least 8 wt. %, at least 8.5 wt. %, at least 9 wt. %, at least 9.5 wt. %, at least 10 wt. %, at least 15 wt. %, at least 20 wt. %, at least 25 wt. %, at least 30 wt. %. In some embodiments of the presently claimed invention, the total weight of the first polymer particle and the second polymer particle present in the coating composition is less than 70 wt. %, for example, less than 65 wt. %, less than 60 wt. %, less than 55 wt. %, less than 50 wt. %, less than 45 wt. %, less than 40 wt. %, less than 35 wt. %. The total weight of the first polymer particle and the second polymer particle present in the coating composition can range from any of the minimum values described above to any of the maximum values described above.

In an embodiment of the presently claimed invention, the coating composition further comprises a filler and/or a pigment. In another embodiment of the presently claimed invention, wherein the filler is selected from the group of clay, kaolin, mica, titanium dioxide, talc, natural silica, synthetic silica, natural silicates, synthetic silicates, feldspars, nepheline syenite, wollastonite, diatomite, barite, aluminum oxide, glass, calcium carbonate, bentonite, magnesium oxide, zinc oxide, attapulgite, perlite, zeolite, and mixtures thereof. In yet another embodiment of the presently claimed invention, the filler is present in the coating composition in an amount in the range of from greater than 0 wt. % to 60 wt. %, or from 5 wt. % to 40 wt. %, based on the total weight of the coating composition.

In another embodiment of the presently claimed invention, the coating composition further comprises a pigment dispersant, an adhesion enhancer, a film forming aid, a defoamer, a thickener, a wetting agent, a biocide, a tackifier, or a combination thereof. In an embodiment of the presently claimed invention, the coating composition can further comprise at least one surfactant, additives, pigments, fillers, dispersants, coalescent, pH modifying agents, plasticizers, salts, oligomers, low molecular weight polymers, defoamers, thickeners, biocides, and combinations thereof.

The choice of additives in the composition will be influenced by a number of factors, including the nature of the multistage polymers or multilayer particles dispersed in the coating composition, as well as the intended use of the composition. In some embodiments, the coating composition comprises less than or equal to 50 grams per liter of volatile organic compounds. Examples of suitable pigments include but are not limited to metal oxides, such as titanium dioxide, zinc oxide, iron oxide, or combinations thereof. Examples of suitable fillers include calcium carbonate, nepheline syenite (25% nepheline, 55% sodium feldspar, and 20% potassium feldspar), feldspar (an aluminosilicate), diatomaceous earth, calcined diatomaceous earth, talc (hydrated magnesium silicate), aluminosilicates, silica (silicon dioxide), alumina (aluminum oxide), clay, (hydrated aluminum silicate), kaolin (kaolinite, hydrated aluminum silicate), mica (hydrous aluminum potassium silicate), pyrophyllite (aluminum silicate hydroxide), perlite, baryte (barium sulfate), Wollastonite (calcium metasilicate), and combinations thereof. In certain embodiments, the composition comprises a calcium carbonate filler.

Examples of suitable dispersants include but are not limited to polyacid dispersants and hydrophobic copolymer dispersants. Polyacid dispersants are typically polycarboxylic acids, such as polyacrylic acid or polymethacrylic acid, which are partially or completely in the form of their ammonium, alkali metal, alkaline earth metal, ammonium, or lower alkyl quaternary ammonium salts. Hydrophobic copolymer dispersants include copolymers of acrylic acid, methacrylic acid, or maleic acid with hydrophobic monomers. In certain embodiments, the composition includes a polyacrylic acid-type dispersing agent, such as Pigment Disperser N, commercially available from BASF SE.

Suitable coalescents, which aid in film formation during drying, include but are not limited to ethylene glycol monomethyl ether, ethylene glycol monobutyl ether, ethylene glycol monoethyl ether acetate, ethylene glycol monobutyl ether acetate, diethylene glycol monobutyl ether, diethylene glycol monoethyl ether acetate, dipropylene glycol monomethyl ether, 2,2,4-trimethyl-1,3-pentanediol monoisobutyrate, and combinations thereof.

Examples of suitable thickening agents include but are not limited to hydrophobically modified ethylene oxide urethane (HEUR) polymers, hydrophobically modified alkali soluble emulsion (HASE) polymers, hydrophobically modified hydroxyethyl celluloses (HMHECs), hydrophobically modified polyacrylamide, and combinations thereof. HEUR polymers are linear reaction products of diisocyanates with polyethylene oxide end-capped with hydrophobic hydrocarbon groups. HASE polymers are homopolymers of (meth)acrylic acid, or copolymers of (meth)acrylic acid, (meth)acrylate esters, or maleic acid modified with hydrophobic vinyl monomers. HMHECs include hydroxyethyl cellulose modified with hydrophobic alkyl chains. Hydrophobically modified polyacrylamides include copolymers of acrylamide with acrylamide modified with hydrophobic alkyl chains (N-alkyl acrylamide). In certain embodiments, the coating composition includes a hydrophobically modified hydroxyethyl cellulose thickener.

Examples of suitable pH modifying agents include but are not limited to amino alcohols, monoethanolamine (MEA), diethanolamine (DEA), 2-(2-aminoethoxy)ethanol, diisopropanolamine (DIPA), 1-amino-2-propanol (AMP), ammonia, and combinations thereof.

Defoamers serve to minimize frothing during mixing and application of the coating composition. Suitable defoamers include but are not limited to silicone oil defoamers, such as polysiloxanes, polydimethylsiloxanes, polyether modified polysiloxanes, and combinations thereof. Exemplary silicone-based defoamers include BYK®-035, available from BYK USA Inc. (Wallingford, Conn.), the TEGO® series of defoamers, available from Evonik Industries (Hopewell, Va.), and the DREWPLUS® series of defoamers, available from Ashland Inc. (Covington, Ky.), FoamStar® ST 2432, FoamStar® ST 2420 from BASF Corporation.

Suitable surfactants include nonionic surfactants and anionic surfactants. Examples of nonionic surfactants include but are not limited to are alkylphenoxy polyethoxyethanols having alkyl groups of about 7 to about 18 carbon atoms and having from about 6 to about 60 oxyethylene units; ethylene oxide derivatives of long chain carboxylic acids; analogous ethylene oxide condensates of long chain alcohols, and combinations thereof. Exemplary anionic surfactants include but are not limited to ammonium, alkali metal, alkaline earth metal, and lower alkyl quaternary ammonium salts of sulfosuccinates, higher fatty alcohol sulfates, aryl sulfonates, alkyl sulfonates, alkylaryl sulfonates, and combinations thereof. In certain embodiments, the composition comprises a nonionic alkylpolyethylene glycol surfactant, such as LUTENSOL® TDA 8 or LUTENSOL® AT-18, commercially available from BASF SE. In certain embodiments, the composition comprises an anionic alkyl ether sulfate surfactant, such as DISPONIL® FES 77, commercially available from BASF SE. In certain embodiments, the composition comprises an anionic diphenyl oxide disulfonate surfactant, such as CALFAX® DB-45, commercially available from Pilot Chemical. In some embodiments, the surfactant can be selected from phosphate surfactant, for e.g., aryl phosphate surfactant. In some embodiments, the composition is substantially free (i.e., the composition includes 0.1% or less by weight) of sulfate surfactants. In some embodiments, the composition is substantially free (i.e., the composition includes 0.1% or less by weight) of sulfonate surfactants. In some embodiments, the composition is substantially free (i.e., the composition includes 0.1% or less by weight) of sulfate surfactants and sulfonate surfactants.

Suitable biocides can be incorporated to inhibit the growth of bacteria and other microbes in the coating composition during storage. Exemplary biocides include but are not limited to 2-[(hydroxymethyl)amino]ethanol, 2-[(hydroxymethyl) amino]2-methyl-1-propanol, o-phenylphenol, sodium salt, 1,2-benzisothiazolin-3-one, 2-methyl-4-isothiazolin-3-one (MIT), 5-chloro2-methyland-4-isothiazolin-3-one (CIT), 2-octyl-4-isothiazolin-3-one (OIT), 4,5-dichloro-2-n-octyl-3-isothiazolone, as well as acceptable salts and combinations thereof. Suitable biocides also include mildewcides that inhibit the growth mildew or its spores in the coating. Examples of mildewcides include 2-(thiocyanomethylthio)benzothiazole, 3-iodo-2-propynyl butyl carbamate, 2,4,5,6-tetrachloroisophthalonitrile, 2-(4-thiazolyl)benzimidazole, 2-N-octyl4-isothiazolin-3-one, diiodomethyl p-tolyl sulfone, as well as acceptable salts and combinations thereof. In certain embodiments, the coating composition contains 1,2-benzisothiazolin-3-one or a salt thereof. Biocides of this type include PROXEL® BD20, commercially available from Arch Chemicals, Inc (Atlanta, Ga.).

Exemplary co-solvents and plasticizers include but are not limited to ethylene glycol, propylene glycol, diethylene glycol, and combinations thereof. Other suitable additives that can optionally be incorporated into the composition include but are not limited to rheology modifiers, wetting and spreading agents, leveling agents, conductivity additives, adhesion promoters, anti-blocking agents, anti-cratering agents and anti-crawling agents, anti-freezing agents, corrosion inhibitors, anti-static agents, flame retardants and intumescent additives, dyes, optical brighteners and fluorescent additives, UV absorbers and light stabilizers, chelating agents, cleanability additives, crosslinking agents, flatting agents, flocculants, humectants, insecticides, lubricants, odorants, oils, waxes and slip aids, soil repellants, stain resisting agents, and combinations thereof.

Any two or more latexes can be combined to make a latex blend composition. In an embodiment of the presently claimed invention, the solids content of the latex blend composition is in an amount in the range of from about 30 wt. % to about 80 wt. %, based on the total weight of the coating composition. In some embodiments of the presently claimed invention, the solid content of the latex blend composition is in an amount in at least 20 wt. %, for example, at least 25 wt. %, at least 30 wt. %, at least 35 wt. %, at least 40 wt. %, at least 45 wt. %, at least 50 wt. %, at least 55 wt. %, at least 60 wt. %, at least 65 wt. %, at least 70 wt. %, at least 75 wt. %. In some embodiments of the presently claimed invention, the solid content of the latex blend composition is in an amount in the range of from is less than 80 wt. %, for example, less than 75 wt. %, less than 70 wt. %, less than 65 wt. %, less than 60 wt. %, less than 55 wt. %, less than 50 wt. %, less than 45 wt. %, less than 35 wt. %. The solid content of the latex blend composition can range from any of the minimum values described above to any of the maximum values described above.

In an embodiment of the presently claimed invention, the coating composition does not comprise a segregation agent or a stratifying promoting agent. Suitable examples of segregation agent or a stratifying promoting agent includes but are not limited to fluorine containing compounds. In another embodiment of the presently claimed invention, the coating composition does not comprise fluorine.

In another embodiment of the presently claimed invention, the coating composition is an ink or a paint or a primer or a formulation comprising paint and primer. In an embodiment of the presently claimed invention, the paint is selected from an aqueous based paint or a solvent-based paint. In another embodiment of the presently claimed invention, the paint is selected from an industrial paint or an architectural paint for interior and exterior applications. In a yet another embodiment of the presently claimed invention, the paint is selected from an aqueous based paint.

Another aspect of the presently claimed invention is directed to a film derived from a coating composition described herein, wherein the film comprises a first surface and a second surface opposite the first surface, after application of the coating composition to a substrate and after drying. For purposes of the presently claimed invention, a first surface is also referred to as a bottom surface, and can be used interchangeably as such, and a second surface is also referred to as a top surface and can be used interchangeably as such.

In an embodiment of the presently claimed invention, the film is a monolayer film formed from a single application of the coating composition. In an embodiment of the presently claimed invention, the thickness of the film is in the range of from about 0.5 microns to about 500 microns. In another embodiment of the presently claimed invention, the thickness of the film is in the range of from about 0.5 microns to about 500 microns, or from about 1 microns to about 100 microns, or from about 5 microns to about 75 microns.

In a yet another embodiment of the presently claimed invention, the first surface comprises at least 50% by weight of the first polymer particles based on the total weight of the first polymer particles and the second surface comprises at least 50% by weight of the second polymer particles based on the total weight of the second polymer particles.

In an embodiment of the presently claimed invention, the first surface and the second surface independently exhibit one or more properties selected from stain resistance, dirt resistance, stain blocking, hardness, adhesion, or a combination thereof. In some embodiments, the first surface and the second surface independently exhibit improvements of one or more properties, the properties selected from stain resistance, dirt resistance, stain blocking, hardness, adhesion, or a combination thereof. In some embodiments, the one or more properties of the first surface is different from the second surface.

In another embodiment of the presently claimed invention, the substrate is an architectural structure, glass, metal, wood, plastic, concrete, vinyl, or ceramic material or another coating layer applied on such a substrate.

Coating compositions can be applied to a surface by any suitable coating technique, including spraying, rolling, brushing, or spreading. Coating compositions can be applied in a single coat, or in multiple sequential coats (e.g., in two coats or in three coats) as required for a particular application. Generally, the coating composition is allowed to dry under ambient conditions. However, in certain embodiments, the coating composition can be dried, for example, by heating and by circulating air over the coating.

The coating compositions can be applied to a variety of surfaces including, but not limited to metal, asphalt, concrete, stone, ceramic, wood, plastic, polyurethane foam, glass, wall board coverings, (e.g., drywall, cement board, etc.), another coating layer applied on such a surface, and combinations thereof. The coating compositions can be applied to interior or exterior surfaces. In certain embodiments, the surface is an architectural surface, such as a roof, wall, floor, or combination thereof. The architectural surface can be located above ground, below ground, or combinations thereof.

Also provided are coatings formed from the coating compositions described herein. Generally, coatings are formed by applying a coating composition described herein to a surface and allowing the coating to dry to form a coating. The coating thickness can vary depending upon the application of the coating.

The polymer particles described above can be prepared by heterophase polymerization techniques, including, for example, free-radical emulsion polymerization, suspension polymerization, and mini-emulsion polymerization. In some examples, it is prepared by polymerizing the monomers using free-radical emulsion polymerization. The emulsion polymerization temperature can range from about 10° C. to about 130° C., for e.g., from about 50° C. to about 90° C. The polymerization medium can include water alone or a mixture of water and water-miscible liquids, such as methanol, ethanol or tetrahydrofuran. In some embodiments, the polymerization medium is free of organic solvents and includes only water.

The emulsion polymerization can be performed with a variety of auxiliaries, including water-soluble initiators and regulators. Examples of water-soluble initiators for the emulsion polymerization are ammonium salts and alkali metal salts of peroxodisulfuric acid, e.g., sodium peroxodisulfate, hydrogen peroxide or organic peroxides, e.g., tert-butyl hydroperoxide. Reduction-oxidation (redox) initiator systems are also suitable as initiators for the emulsion polymerization. The redox initiator systems are composed of at least one, usually inorganic, reducing agent and one organic or inorganic oxidizing agent. The oxidizing component comprises, for example, the initiators already specified above for the emulsion polymerization. The reducing components are, for example, alkali metal salts of sulfurous acid, such as sodium sulfite, sodium hydrogen sulfite, alkali metal salts of disulfurous acid such as sodium disulfite, bisulfite addition compounds with aliphatic aldehydes and ketones, such as acetone bisulfite, or reducing agents such as hydroxymethanesulfinic acid and salts thereof, or ascorbic acid. The redox initiator systems can be used in the company of soluble metal compounds whose metallic component is able to exist in a plurality of valence states. Typical redox initiator systems include, for example, ascorbic acid/iron(II) sulfate/sodium peroxodisulfate, tert-butyl hydroperoxide/sodium disulfite, tert-butyl hydroperoxide/Na hydroxymethanesulfinate, or tert-butyl hydroperoxide/ascorbic acid. The individual components, the reducing component for example, can also be mixtures, an example being a mixture of the sodium salt of hydroxymethanesulfinic acid with sodium disulfite. The stated compounds are used usually in the form of aqueous solutions, with the lower concentration being determined by the amount of water that is acceptable in the dispersion, and the upper concentration by the solubility of the respective compound in water. The concentration can be from about 0.1% to about 30%, about 0.5% to about 20%, or about 1% to about 10%, by weight, based on the solution. The amount of the initiators is generally about 0.1% to about 10% or about 0.5% to about 5% by weight, based on the monomers to be polymerized. It is also possible for two or more different initiators to be used in the emulsion polymerization. For the removal of the residual monomers, an initiator can be added after the end of the emulsion polymerization.

In the polymerization it is possible to use molecular weight regulators or chain transfer agents, in amounts, for example, of 0 to 0.8 parts by weight, based on 100 parts by weight of the monomers to be polymerized, to reduce the molecular weight of the copolymer. Suitable examples include compounds having a thiol group such as tert-butyl mercaptan, thioglycolic acid ethylacrylic esters, mercaptoethanol, mercaptopropyltrimethoxysilane, and tert-dodecyl mercaptan. Additionally, it is possible to use regulators without a thiol group, such as terpinolene. In some embodiments, the emulsion polymer is prepared in the presence of greater than 0% to 0.5% by weight, based on the monomer amount, of at least one molecular weight regulator. In some embodiments, the emulsion polymer is prepared in the presence of less than less than 0.3% or less than 0.2% by weight (e.g., 0.10% to 0.15% by weight) of the molecular weight regulator.

Dispersants, such as surfactants, can also be added during polymerization to help maintain the dispersion of the monomers in the aqueous medium. For example, the polymerization can include less than 3% by weight or less than 1% by weight of surfactants. In some embodiments, the polymerization is substantially free of surfactants and can include less than 0.05% or less than 0.01% by weight of one or more surfactants. In other embodiments, the first emulsion polymerization step and the second polymerization step further comprise an aryl phosphate surfactant. (e.g., a tristyrylphenol alkoxylated phosphate surfactant).

Anionic and nonionic surfactants can be used during polymerization. Suitable surfactants include ethoxylated C₈ to C₃₆ or C₁₂ to C₁₈ fatty alcohols having a degree of ethoxylation of from about 3 to about 50 or of about 4 to about 30, ethoxylated mono-, di-, and tri-C₄ to C₁₂ or C₄ to C₉ alkylphenols having a degree of ethoxylation of 3 to 50, alkali metal salts of dialkyl esters of sulfosuccinic acid, alkali metal salts and ammonium salts of C₈ to C₁₂ alkyl sulfates, alkali metal salts and ammonium salts of C₁₂ to C₁₈ alkylsulfonic acids, and alkali metal salts and ammonium salts of C₉ to C₁₈ alkylarylsulfonic acids.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

### Embodiments of the Invention

In the following, there is provided a list of embodiments to further illustrate the present disclosure without intending to limit the disclosure to the specific embodiments listed below.

Embodiment 1: A coating composition, comprising:

a plurality of latex polymer particles, comprising,
(i) a first polymer particle having a first volume average particle size diameter in the range of from about 20 nm to about 1,000 nm, determined according to dynamic light scattering method;
(ii) a second polymer particle having a second volume average particle size diameter in the range of from about 5 nm to about 250 nm, determined according to dynamic light scattering method;
   wherein the second volume average particle size diameter to the first volume average particle size diameter is in ratio in the range of from about 1:20 to about 1:4, and
   wherein at least one of the first polymer particle and the second polymer particle comprise one or more ethylenically unsaturated monomers.

Embodiment 2: The coating composition according to embodiment 1, wherein the first volume average particle size diameter is in the range of from about 20 nm to about 1000 nm, or from about 50 nm to about 750 nm, or from about 150 nm to about 500 nm, determined according to dynamic light scattering method.

Embodiment 3: The coating composition according to embodiment 1 or 2, wherein the first polymer particle has a theoretical glass transition temperature in the range of from about −70° C. to about 50° C. or from about −10° C. to about 25° C., measured using differential scanning calorimetry (DSC).

Embodiment 4: The coating composition according to any of embodiments 1 to 3, wherein the first polymer particle has a number average molecular weight in the range of from about 15,000 Da to about 500,000 Da, determined according to gel permeation chromatography.

Embodiment 5: The coating composition according to any of embodiments 1 to 4, wherein the first polymer particle comprises a polymer selected from the group of (meth)acrylic homopolymers, (meth)acrylic-based copolymers, styrene-acrylic-based copolymers, styrene-butadiene-based copolymers, styrene-butadiene-styrene block copolymers, vinyl acrylic-based copolymers, ethylene vinyl acetate-based copolymers, alkyd resin, polyester resins, polyurethane resins, silicone resins, petroleum resins, epoxy resins, and blends thereof.

Embodiment 6: The coating composition according to any of embodiments 1 to 5, wherein the first polymer particle comprises a polymer selected from the group of acrylic homopolymers, acrylic-based copolymers, styrene-acrylic-based copolymers, and blends thereof.

Embodiment 7: The coating composition according to any of embodiments 1 to 6, wherein the second volume average particle size diameter is in the range of from about 10 nm to about 200 nm, or from about 10 nm to about 150 nm, determined according to dynamic light scattering method.

Embodiment 8: The coating composition according to any of embodiments 1 to 7, wherein the second polymer particle has a theoretical glass transition temperature in the range of from about −20° C. to about 140° C., from about 0° C. to about 140° C., or from about 20° C. to about 130° C., measured using differential scanning calorimetry (DSC).

Embodiment 9: The coating composition according to any of embodiments 1 to 8, wherein the second polymer particle has a number average molecular weight in the range of from about 1,000 Da to about 200,000 Da, determined according to gel permeation chromatography.

Embodiment 10: The coating composition according to any of embodiments 1 to 9, wherein the second polymer particle comprises a polymer selected from the group of acrylic homopolymers, acrylic-based copolymers, styrene-acrylic-based copolymers, styrene-butadiene-based copolymers, styrene-butadiene-styrene block copolymers, vinyl acrylic-based copolymers, ethylene vinyl acetate-based copolymers, alkyd resin, polyester resins, polyurethane resins, silicone resins, petroleum resins, epoxy resins, and blends thereof.

Embodiment 11: The coating composition according to any of embodiments 1 to 10, wherein the second polymer particle comprises a polymer selected from the group of acrylic homopolymers, acrylic-based copolymers, styrene-acrylic-based copolymers, and blends thereof.

Embodiment 12: The coating composition according to any of embodiments 1 to 11, wherein the ratio of the second average particle size diameter to the first average particle size diameter is in the range of from about 1:20 to about 1:4, or from about 1:10 to about 1:5.

Embodiment 13: The coating composition according to any of embodiments 1 to 12, wherein the weight ratio of the first polymer particle to the second polymer particle is in the range of from about 1:100 to about 100:1, about 1:50 to about 50:1, or from about 1:20 to about 20:1, or from about 1:10 to about 10:1.

Embodiment 14: The coating composition according to any of embodiments 1 to 13, wherein the total weight of the first polymer particle and the second polymer particle present in the coating composition is in an amount in the range of from about 2.5 wt. % to about 60 wt. %, or from about 5 wt. % to about 60 wt. %, or from about 10 wt. % to about 40 wt. % based on the total weight of the coating composition.

Embodiment 15: The coating composition according to any of embodiments 1 to 14, further comprising a filler and pigment.

Embodiment 16: The coating composition according to embodiment 15, wherein the filler is selected from the group of clay, kaolin, mica, titanium dioxide, talc, natural silica, synthetic silica, natural silicates, synthetic silicates, feldspars, nepheline syenite, wollastonite, diatomite, barite, aluminum oxide, glass, calcium carbonate, bentonite, magnesium oxide, zinc oxide, attapulgite, perlite, zeolite, and mixtures thereof.

Embodiment 17: The coating composition according to embodiment 15 or 16, wherein the filler is present in the coating composition in an amount in the range of from about greater than 0 wt. % to about 60 wt. %, or from about 5 wt. % to about 40 wt. %, based on the total weight of the coating composition.

Embodiment 18: The coating composition according to any of embodiments 1 to 17, further comprising a pigment dispersant, an adhesion enhancer, a film forming aid, a defoamer, a thickener, a wetting agent, a biocide, a tackifier, or a combination thereof.

Embodiment 19: The coating composition according to any of embodiments 1 to 18, wherein the coating composition does not include a segregation agent or a stratifying promoting agent.

Embodiment 20: The coating composition according to any of embodiments 1 to 19, wherein the coating composition is an ink or a paint or a primer or a formulation comprising paint and primer.

Embodiment 21: The coating composition according to embodiment 20, wherein the paint is selected from an aqueous based paint or a solvent-based paint.

Embodiment 22: The coating composition according to embodiment 20, wherein the paint is selected from an industrial paint or an architectural paint for interior and exterior applications.

Embodiment 23: A film derived from a coating composition according to any one of embodiments 1 to 22, wherein the film comprises a first surface and a second surface opposite the first surface, after application of the coating composition to a substrate and after drying.

Embodiment 24: The film according to embodiment 23, wherein the film is a monolayer film formed from a single application of the coating composition.

Embodiment 25: The film according to embodiment 23 or 24, wherein the thickness of the film is in the range of from about 0.5 microns to about 500 microns, or from about 5 microns to about 75 microns.

Embodiment 26: The film according to any one of embodiments 23 to 25, wherein the first surface comprises at least 50% by weight of the first polymer particles based on the total weight of the first polymer particles and the second surface comprises at least 50% by weight of the second polymer particles based on the total weight of the second polymer particles.

Embodiment 27: The film according to any one of embodiments 23 to 26, wherein the first surface and the second surface independently exhibit improvements of one or more properties selected from stain resistance, dirt resistance, stain blocking, gloss, hardness, adhesion, or a combination thereof.

Embodiment 28: The film according to any one of embodiments 23 to 27, wherein the substrate is an architectural structure, glass, metal, wood, plastic, concrete, vinyl, or ceramic material or another coating layer applied on such a substrate.

While the presently claimed invention has been described in terms of its specific embodiments, certain modifications and equivalents will be apparent to those skilled in the art and are intended to be included within the scope of the presently claimed invention.

The presently claimed invention is associated with at least one of the following advantages:
(i) The presently claimed invention provides good coating properties like adhesion, stain resistance, stain blocking, flexibility and pendulum hardness.
(ii) The coating compositions of the presently claimed invention do not require special curing (elevated temperature, UV-light) conditions to self-stratify.
(iii) The coating compositions of the presently claimed invention do not require stratifying agents or segregation agent to enable stratification of the surfaces of coating.
(iv) The coating compositions of the presently claimed invention do not include any fluoride component, crosslinking agents, organic solvents, volatile organic compounds (VOCs) and other additives such as coalescent agents that pose health hazard.
(v) The coating compositions of the presently claimed invention are environment friendly.
(vi) The presently claimed invention enable single application of coating and is advantageous over multiple coating application and multiple drying steps.
(vii) The coating compositions of the presently claimed invention is useful for architectural, industrial, construction, and automotive coatings.

### Examples

Aspects of the presently claimed invention are more fully illustrated by the following examples, which are set forth to illustrate certain aspects of the present invention and are not to be construed as limiting thereof.

A latex is an emulsion of polymer particles. Any two or more latexes can be combined to make a latex blend composition.

Water may be added to any latex or latex blend composition to modify the solids content. Blending does not assume any procedural order of addition.

First latex: A first latex was prepared having an emulsion of first polymer particles with a first volume average particle size diameter of 250 nm, comprising a first polymer comprising an acrylic copolymer having a glass transition temperature, Tg, of 8° C. derived from one or more ethylenically-unsaturated monomers. The first latex had a solids content of 53.3 wt. %.

Second latex: A second latex was prepared having an emulsion of second polymer particles with a second volume average particle size diameter of 27 nm, comprising a second polymer comprising a styrene-acrylic polymer having a glass transition temperature, Tg, of about 80° C. derived from one or more ethylenically-unsaturated monomers. The second latex had a solids content of 33.5 wt. %. The second polymer has a number average molecular weight of 16,000 Dalton (Da).
Third latex: A third latex was prepared having an emulsion of third polymer particles with a third volume average particle size diameter of 43 nm, comprising a third polymer comprising a styrene-acrylic polymer having a glass transition temperature, Tg, of about 120° C. derived from one or more ethylenically-unsaturated monomers. The third latex had a solids content of 19 wt. %. The third polymer has a number average molecular weight of 8500 Dalton (Da). The first latex and the second latex were blended at varying ratios to give targeted first polymer to second polymer weight ratios, described in Examples 2 to 5. The first latex and the third latex were blended at varying ratios to give targeted first polymer to third polymer weight ratios, described in Examples 6 to 8.

Example 1 (Comparative): The first latex was diluted with de-ionized water to give a solids content of 40 wt. %.

Example 2: A first latex blend composition was prepared by combining the first latex and the second latex to yield a first polymer to second polymer weight ratio of 90/10. The first latex blend composition was diluted with de-ionized water to give a solids content of 40 wt. %. The ratio of the second volume average particle size diameter to first volume average particle size diameter is approximately 1:9.

Example 3: A second latex blend composition was prepared by combining the first latex and the second latex to yield a first polymer to second polymer weight ratio of 80/20. The second latex blend composition was diluted with de-ionized water to give a solids content of 40 wt. %. The ratio of the second volume average particle size diameter to second volume average particle size diameter is approximately 1:9.

Example 4: A third latex blend composition was prepared by combining the first latex and the second latex to yield a first polymer to second polymer weight ratio of 70/30. The third latex blend composition was diluted with de-ionized water to give a solids content of 40 wt. %. The ratio of the second volume average particle size diameter to first volume average particle size diameter is approximately 1:9.

Example 5: A fourth latex blend composition was prepared by combining the first latex and the second latex to yield a first polymer to second polymer weight ratio of 50/50. The fourth latex blend composition was diluted with de-ionized water to give a solids content of 40 wt. %. The ratio of the second volume average particle size diameter to first volume average particle size diameter is approximately 1:9.

Example 6: A fifth latex blend composition was prepared by combining the first latex and the third latex to yield a first polymer to third polymer weight ratio of 90/10. The fifth latex blend composition was diluted with de-ionized water to give a solids content of 40 wt. %. The ratio of the third volume average particle size diameter to first volume average particle size diameter is approximately 1:6.

Example 7: A sixth latex blend composition was prepared by combining the first latex and the third latex to yield a first polymer to third polymer weight ratio of 80/20. The sixth latex blend composition was diluted with de-ionized water to give a solids content of 39 wt. %. The ratio of the third volume average particle size diameter to first volume average particle size diameter is approximately 1:6.

Example 8: A seventh latex blend composition was prepared by combining the first latex and the third latex to yield a first polymer to third polymer weight ratio of 70/30. The seventh latex blend composition was diluted with de-ionized water to give a solids content of 35 wt. %. The ratio of the third volume average particle size diameter to first volume average particle size diameter is approximately 1:6.

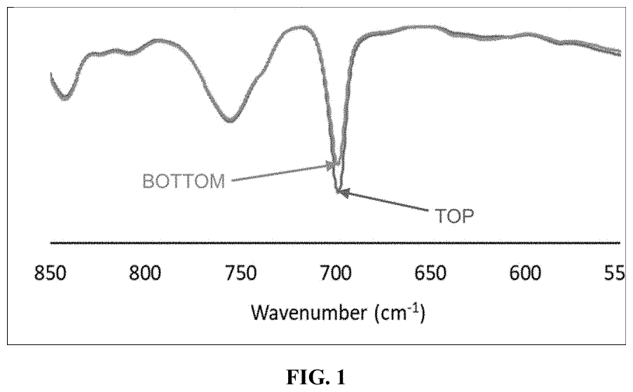

Method for measuring surface enrichment/stratification by ATR-FTIR Stratification of latex blend compositions was measured by Attenuated Total Reflectance Fourier Transform Infrared Spectroscopy (ATR-FTIR). Spectra were collected for bottom (first) and top (second) sides of ambient dried films of latexes and latex blend compositions. Comparative peak integrations of identified peaks quantified the relative concentration of each latex polymer on each the top and bottom sides of the dried films. As an illustration, for Example 2, ATR-FTIR spectra of both the top and bottom sides of an ambient dried film formed in the carbonyl stretch region comprised of contributions from both the first latex polymer and the second latex polymer was measured from 1800 cm⁻¹ to 1650 cm⁻¹ and compared against the styrene C—H bend at 720 cm⁻¹ to 680 cm⁻¹ (FIG. 1). The relative concentrations of the first polymer and the second polymer are then compared to yield a surface enrichment. The surface enrichment is a compound ratio of a first ratio, here defined as the relative concentration of the second polymer on the top of the film to the concentration of the first polymer on the top of the film, to the a second ratio, here defined as the relative concentration of the second polymer on the bottom of the film to the concentration of the first polymer on the bottom of the film.

$$Surface Enrichment = \frac{\begin{matrix}[ second polymer on top ] / \\ [ first polymer on top ]\end{matrix}}{\begin{matrix}[ second polymer on bottom ] / \\ [ first polymer on bottom ]\end{matrix}}$$

Here the surface enrichment values quantify the amount of the second latex that has preferentially segregated to the ‘top’ surface of the dried film. A higher surface enrichment therefore means a larger difference in the composition of the top of the film versus the bottom of the film. For example, a surface enrichment value of 2.5 means the concentration of second latex particles on the ‘top’ of the film is 2.5 times the concentration of second latex particles on the ‘bottom’ of the film.
Calculations of surface enrichment between the first polymer and the third polymer follow similarly as described for the first polymer and second polymer.

TABLE 1
Measured surface enrichment/stratification results
for the latexes and latex blend compositions.

| | First | Second | Third | |
|---|---|---|---|---|
| | polymer | polymer | polymer | Surface |
| | (wt. %) | (wt. %) | (wt. %) | Enrichment |
| Comparative | 100 | | | 1.0 |
| Example 1 | | | | |
| Example 2 | 90 | 10 | | 1.5 |
| Example 3 | 80 | 20 | | 1.8 |
| Example 4 | 70 | 30 | | 2.5 |
| Example 5 | 50 | 50 | | 1.4 |
| Example 6 | 90 | | 10 | 1.5 |
| Example 7 | 80 | | 20 | 1.9 |
| Example 8 | 70 | | 30 | 1.1 |

Coating compositions: Coating compositions were made according to Table 2. The individual components in the grind phase were weighed and added under high agitation using a high shear tooth-disk stirrer in the amount (wt. %) as indicated. Agitation commenced until all large aggregates were transformed into their primary particles. This point was determined via a Hegman Gauge. Stirring speed was then decreased and the let down components weighed and then slowly added to ensure that the composition was smooth.

The total weight of the first and second particles based on the total weight of the coating composition in the Comparative Example 1, Examples 9 and 10 in Table is in the range of from 22 wt. % to 24 wt. %.

TABLE 2
Coating Compositions

| | Comparative | | |
|---|---|---|---|
| | Example 1 | Example 9 | Example 10 |
| | (wt. %) | (wt. %) | (wt. %) |
| Grind | | | |
| Water | 1.1 | 1.1 | 1.1 |
| Rheology | 0.0 | 0.0 | 0.0 |
| modifier 1 | | | |
| Pigment | 31.7 | 31.6 | 30.2 |
| Dispersant | 0.7 | 0.7 | 0.6 |
| Surfactant | 0.7 | 0.7 | 0.6 |
| Defoamer 1 | 0.1 | 0.1 | 0.1 |
| Rheology | 0.2 | 0.2 | 0.2 |
| modifier 2 | | | |
| Let Down | | | |
| Example 1 | 60.2 | 0.0 | 0.0 |
| Example 4 | 0.0 | 60.0 | 0.0 |
| Example 7 | 0.0 | 0.0 | 57.3 |
| Defoamer 2 | 0.5 | 0.5 | 0.4 |
| Rheology | 2.3 | 2.3 | 7.0 |
| modifier 3 | | | |
| Preservative 1 | 0.4 | 0.4 | 0.4 |
| Preservative 2 | 0.2 | 0.2 | 0.2 |
| Thickener | 0.9 | 1.3 | 0.9 |
| Coalescent | 1.0 | 0.9 | 0.9 |

where,
Rheology modifier 1 is Natrosol™ 250 HBR obtained from Ashland,
Pigment is Kronos® 4311 obtained from Kronos Worldwide Inc.,
Dispersant is Tamol® 165A obtained from Dow Chemical Company,
Surfactant is Hydropalat® WE 3320 obtained from BASF Corporation,
Defoamer 1 is FoamStar® ST 2432 obtained from BASF Corporation,
Rheology modifier 2 is Attagel® 50 obtained from BASF Corporation,
Defoamer 2 is FoamStar® ST 2420 obtained from BASF Corporation,
Rheology modifier 3 is Aquaflow™ NHS 310 obtained from Ashland,
Preservative 1 is Polyphase® 678 obtained from Troy Corporation,
Preservative 2 is Proxel™ BD 20 obtained from Lonza,
Thickener is Rheovis® PU 1251 obtained from BASF Corporation,
Coalescent is Texanol™ obtained from Eastman Chemical Company

Methods of Testing Coating Composition Properties:

Stain Blocking: The stain blocking capability of the coating composition was assessed by spectrally measuring the delta E as a means to determine the formulations ability to hide stains on a substrate as compared to a control.

Samples were prepared to assess the stain blocking capability of the coating composition against a variety of stains. Samples were prepared by applying a series of stains on top of a film formed from a fully cured commercially available low VOC, 100% acrylic flat paint. The stains were dried for 24 hours at room temperature. A 7-mil film of the coating formulation was then applied over the top of the stains and allowed to dry for 24 hours. Once dried, samples were either visually compared against the comparative control or the absolute delta E value was measured with a spectrophotometer. Samples with lower delta E compared to the comparative control were deemed improved samples.

Stain Resistance: The stain resistance of coating compositions was measured using the method described in ASTM D 4828-94(2012) entitled “Standard Test Methods for Practical Washability of Organic Coatings,” which is incorporated herein by reference in its entirety. The test measured the degree of removal of stains applied to a dried coating.

A 10-mil film of paint formulation was applied to a Leneta Black Scrub Panel. After 7 days of curing at 23° C. and 50% relative humidity, a series of “stains” were applied on top of the dried paint film. After 1-hour, excess stain material was gently washed off and blotted dry. Panels were then scrubbed for 50 cycles with a sponge and 50 cc of Leneta SC-1 (Standardized Scrub Medium Non-Abrasive type). Once dried, samples were either visually compared against the comparative control or the absolute delta E value was measured with a spectrophotometer. Samples with lower delta E compared to the comparative control were deemed improved samples.

Dirt Pickup Resistance: The Accelerated Dirt Pickup Resistance was used as a means to test the coatings ability to resist adsorbed dirt that strongly binds to the coating surface. A 10-mil film of paint formulation was applied to a Leneta Black Scrub Panel. After 24 hours of curing at 23° C. and 50% relative humidity the panel was exposed to QUV-A light for 24 hours. The panel was then coated with carbon black powder and placed in the oven at 50° C. for 1 hour. Sample was removed, carbon black powder tapped off and the y-reflectance measured with a spectrophotometer. Samples with lower y-reflectance values compared to the comparative control were deemed improved samples.

Pendulum Hardness: Pendulum Hardness of the final coating was conducted in accordance with ASTM D4366-16, Method A. Coatings were applied to a glass plate and let cure for 3 or 7 days at 23° C. and 50% relative humidity. The final hardness was recorded by number of pendulum oscillations.

Adhesion: The adhesion of coating compositions was measured using the method described in ASTM D 3359-09e2 entitled “Standard Test Methods for Measuring Adhesion by Tape Test,” which is incorporated herein by reference in its entirety. Test method B was used with 7 mil wet film thicknesses applied to a cured alkyd coated panel, steel panel and aluminum panel. After 1- or 7-days storage at 23° C. and 50% relative humidity the adhesion 2 mm crosscut adhesion test was performed. A visual adhesion rating was noted for each coating (0B—little or no adhesion; 1B—20% adhesion; 2B—40% adhesion; 3B—60% adhesion; 4B—80% adhesion; 5B—100% adhesion).

Bend Test: A Conical Mandrel Bend was conducted in accordance with ASTM D533 on coatings to determine the flexibility of the coating. A 7 mil wet film thicknesses were applied to a an aluminum panel and cured for 7 days at 23° C. and 50% relative humidity. Samples were fully bent in the conical mandrel bend apparatus (Gardco TQC Bend Test) at room temperature. Samples were rated as pass or fail based upon the appearance of cracking and at what diameter the crack occurred.

TABLE 3
Properties of the representative coating compositions from Table 2

| | | Comparative | | |
|---|---|---|---|---|
| | Parameter | Example 1 | Example 9 | Example 10 |
| Stain Resistance | | | | |
| Red Wine | ΔE | 19 | 3.6 | 8.3 |
| Grape Juice | ΔE | 14.1 | 2.2 | 3.6 |
| Coffee | ΔE | 10.4 | 7.6 | 7.6 |
| Tea | ΔE | 13.7 | 5.0 | 6.8 |
| Mustard | ΔE | 11.7 | 9.1 | 8.7 |
| Lipstick | visual | N/A | improved | improved |
| | rating* | | | |
| Stain Block | | | | |
| Permanent | ΔE | 1.7 | 0.7 | 0.8 |
| Marker | | | | |
| Crayon | ΔE | 1.40 | 1.1 | 1.2 |
| Lipstick | ΔE | 15.4 | 14.4 | 17.4 |
| Dirt Pickup | | | | |
| Resistance | | | | |
| y-reflectance initial | L* | 92 | 92 | 92 |
| (after 24-hour | | | | |
| QUV-B) | | | | |
| y-reflectance final | L* | 68 | 79 | 77 |
| (24-hour QUV-B + | | | | |
| dirt) | | | | |
| Conical Mandrel | | | | |
| Bend | | | | |
| 7-day cure | | Pass | Pass | Pass |
| Pendulum Hardness | | | | |
| 3-day cure | Oscillation | 6 | 15 | 13 |
| 7-day cure | Oscillation | 7 | 19 | 17 |
| Adhesion | | | | |
| Alkyd - dry, | visual | 4B | B | 4B |
| 1-day cure | rating | | | |
| Alkyd - dry, | visual | 4B | 4B | 4B |
| 7-day cure | rating | | | |
| Aluminum - dry, | visual | 1B | 5B | 4B |
| 1-day cure | rating | | | |
| Aluminum - dry, | visual | 0B | 5B | 5B |
| 7-day cure | rating | | | |
| Galvanized Steel - | visual | 1B | 4B | 4B |
| dry, 1-day cure | rating | | | |
| Galvanized Steel - | visual | 1B | 5B | 4B |
| dry, 7-day cure | rating | | | |

*visual rating compared against Comparative Example 1.

The compositions and methods of the appended claims are not limited in scope by the specific compositions and methods described herein, which are intended as illustrations of a few aspects of the claims and any compositions and methods that are functionally equivalent are intended to fall within the scope of the claims. Various modifications of the compositions and methods in addition to those shown and described herein are intended to fall within the scope of the appended claims. Further, while only certain representative compositions and method steps disclosed herein are specifically described, other combinations of the compositions and method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated. The term “comprising”, and variations thereof as used herein is used synonymously with the term “including” and variations thereof and are open, non-limiting terms. Although the terms “comprising” and “including” have been used herein to describe various embodiments, the terms “consisting essentially of” and “consisting of” can be used in place of “comprising” and “including” to provide for more specific embodiments of the invention and are also disclosed. Other than in the examples, or where otherwise noted, all numbers expressing quantities of ingredients, reaction conditions, and so forth used in the specification and claims are to be understood at the very least, and not as an attempt to limit the application of the doctrine of equivalents to the scope of the claims, to be construed in light of the number of significant digits and ordinary rounding approaches.

### Discussion of Results

The stratification of latex blend compositions measured by Attenuated Total Reflectance Fourier Transform Infrared Spectroscopy (ATR-FTIR) and surface enrichment values as shown in Table 1 indicates that the latex blend compositions of the presently claimed invention enable self-stratification or self-segregation. A higher surface enrichment value of greater than 1.0 for the Examples 2-8 in comparison to the comparative Example 1 (surface enrichment=1.0) indicates a difference in the composition of the top of the film versus the bottom of the film and preferential segregation of the polymer particles to the top and bottom surfaces of the film. Stratification is driven largely by particle size differences, but is not limited to particle size differences alone, where the particle populations are substantially different. For example, the selection of the first polymer particle and second polymer particle in the coating compositions can enable the coating to adhere well on the “bottom” of the film and have better durability (e.g., stain resistance) on the top of the film, making it highly suitable for architectural coating.

The coating compositions of the presently claimed invention as shown by representation in Examples 9 and 10 do not require special curing (elevated temperature, UV-light) conditions to self-stratify. In most cases, stratification can be achieved in ambient drying conditions.

The results in Table 3 are indicative of the performance properties of the representative coating compositions from Table 2. The results in Tale 3 show that the coating compositions of the presently claimed invention can be used to affect stain resistance, stain block, pendulum hardness, adhesion, flexibility and dirt pickup resistance on coating. From the results recorded in the Table 3, it is apparent that the coating compositions according to the presently claimed invention show excellent properties that makes it suitable for most coating applications like architectural, industrial, construction and automotive coatings. The improved properties of coated substrate results from the components of the composition that lend to a unique heterogeneity within the film, specifically the final localization of the first polymer particle and the second polymer particle in the ambient dried coating composition disclosed herein.

The ratio of volume average particle size of the first polymer particle and second polymer particle in the coating composition and the ratio of the weight of the first latex solution to the second latex solution in the latex blend compositions forming the coating compositions drive the segregating behaviour of the coating on application on a substrate. However, these are not the only parameters that drive the stratification. The segregating behavior of a self-stratifying coating then allows for critical coating properties like adhesion, stain resistance, stain blocking, pendulum hardness, dirt pickup resistance, flexibility to be independently tailored and targeted at the different sides of the film.

### Test Methods

Molecular weight determination: Gel permeation chromatography (GPC) spectra were acquired with a Waters 2695 instrument and was used to determine molecular weight of polymers using tetrahydrofuran (THF) as the mobile phase at 40° C. and a refractive index (RI) detector. All samples were analysed for number average molecular weight (Mn), weight average molecular weight (Mw), and polydispersity (PDI) using elution times calibrated against polystyrene molecular weight standards. The number average molecular weight (Mn) is the statistical average molecular weight of all the polymer chains in the polymer and is defined by:

Mₙ=(ΣNᵢMᵢ)/ΣNᵢ

where Mi is the molecular weight of a chain and Ni is the number of chains of that molecular weight.
The weight average molecular weight (Mw) is defined by:

M_{w}=(ΣNiMi²)/ΣNi

Compared to Mn, Mw considers the molecular weight of a chain in determining contributions to the molecular weight average. The more massive the chain, the more the chain contributes to Mw.

Higher average molecular weights (Mz) can be defined by the equation:

M_{z}=(ΣNiMi³)/ΣNi

Solid content determination: The solid content of the dispersions was measured with a microwave moisture analyser.

Particle size determination including volume average particle size: Particle size of the dispersions were measured using a nano-flex particle sizer from Microtrac using Dynamic Light Scattering technique.

Glass Transition Temperature determination: Glass transition temperature (Tg) was measured by Differential Scanning calorimetry (DSC) using a heat-cool-heat method according to ASTM D 3418-12e1.

1.-28. (canceled)

29. A coating composition, comprising
a plurality of latex polymer particles, comprising,
i) a first polymer particle having a first volume average particle size diameter in the range of from about 20 nm to about 1,000 nm, determined according to dynamic light scattering method; and
ii) a second polymer particle having a second volume average particle size diameter in the range of from about 5 nm to about 250 nm, determined according to dynamic light scattering method;
wherein the second volume average particle size diameter to the first volume average particle size diameter has a ratio in the range of from about 1:20 to about 1:4, and
wherein at least one of the first polymer particle and the second polymer particle comprises one or more ethylenically unsaturated monomers.

30. The coating composition according to claim 29, wherein the first volume average particle size diameter is in the range of from about 20 nm to about 1000 nm determined according to dynamic light scattering method.

31. The coating composition according to claim 29, wherein the first polymer particle has a theoretical glass transition temperature in the range of from about −70° C. to about 50° C., measured using differential scanning calorimetry, the first polymer particle has a number average molecular weight in the range of from about 15,000 Da to about 500,000 Da, determined according to gel permeation chromatography, and the first polymer particle comprises a polymer selected from the group of acrylic homopolymers, acrylic-based copolymers, styrene-acrylic-based copolymers, styrene-butadiene-based copolymers, styrene-butadiene-styrene block copolymers, vinyl acrylic-based copolymers, ethylene vinyl acetate-based copolymers, alkyd resin, polyester resins, polyurethane resins, silicone resins, petroleum resins, epoxy resins, and blends thereof.

32. The coating composition according to claim 29, wherein the first polymer particle comprises a polymer selected from the group of acrylic homopolymers, acrylic-based copolymers, styrene-acrylic-based copolymers, and blends thereof.

33. The coating composition according to claim 29, wherein the second volume average particle size diameter is in the range of from about 10 nm to about 200 nm, determined according to dynamic light scattering method, the second polymer particle has a theoretical glass transition temperature in the range of from about −20° C. to about 140° C., measured using differential scanning calorimetry, and the second polymer particle has a number average molecular weight in the range of from about 1,000 Da to about 200,000 Da, determined according to gel permeation chromatography.

34. The coating composition according to claim 29, wherein the second polymer particle comprises a polymer selected from the group of acrylic homopolymers, acrylic-based copolymers, styrene-acrylic-based copolymers, styrene-butadiene-based copolymers, styrene-butadiene-styrene block copolymers, vinyl acrylic-based copolymers, ethylene vinyl acetate-based copolymers, alkyd resin, polyester resins, polyurethane resins, silicone resins, petroleum resins, epoxy resins, and blends thereof.

35. The coating composition according to claim 29, wherein the second polymer particle comprises a polymer selected from the group of acrylic homopolymers, acrylic-based copolymers, styrene-acrylic-based copolymers, and blends thereof.

36. The coating composition according to claim 29, wherein the ratio of the second volume average particle size diameter to the first volume average particle size diameter is in the range of from about 1:20 to about 1:4.

37. The coating composition according to claim 29, wherein the weight ratio of the first polymer particle to the second polymer particle is in the range of from about 1:100 to about 100:1.

38. The coating composition according to claim 29, wherein the total weight of the first polymer particle and the second polymer particle present in the coating composition is in an amount in the range of from about 2.5 wt. % to about 70 wt. %, based on the total weight of the coating composition.

39. The coating composition according to claim 29, further comprising a filler and pigment.

40. The coating composition according to claim 39, wherein the filler is selected from the group of clay, kaolin, mica, titanium dioxide, talc, natural silica, synthetic silica, natural silicates, synthetic silicates, feldspars, nepheline syenite, wollastonite, diatomite, barite, aluminum oxide, glass, calcium carbonate, bentonite, magnesium oxide, zinc oxide, attapulgite, perlite, zeolite, and mixtures thereof, and the filler is present in the coating composition in an amount up to about 60 wt. %, based on the total weight of the coating composition.

41. The coating composition according to claim 29, further comprising at least one of a pigment dispersant, an adhesion enhancer, a film forming aid, a defoamer, a thickener, a wetting agent, a biocide, and a tackifier.

42. The coating composition according to claim 29, wherein the coating composition does not include a segregation agent or a stratifying promoting agent.

43. The coating composition according to claim 29, wherein the coating composition is at least one of an ink, a paint, and a primer.

44. The coating composition according to claim 43, wherein the coating composition is a paint selected the group of an aqueous-based paint and a solvent-based paint.

45. The coating composition according to claim 43, wherein the coating composition is a paint selected from the group of an industrial paint and an architectural paint for interior and exterior applications.

46. A film derived from a coating composition according to claim 29, wherein the film comprises a first surface and a second surface opposite the first surface, after application of the coating composition to a substrate and after drying.

47. The film according to claim 46, wherein the film is a monolayer film formed from a single application of the coating composition.

48. The film according to claim 46, wherein a thickness of the film is in the range of from about 0.5 microns to about 500 microns.

49. The film according to claim 46, wherein the first surface comprises at least 50% by weight of the first polymer particles based on the total weight of the first polymer particles and the second surface comprises at least 50% by weight of the second polymer particles based on the total weight of the second polymer particles.

50. The film according to claim 46, wherein the first surface and the second surface independently exhibit improvements of one or more properties selected from stain resistance, dirt resistance, stain blocking, gloss, hardness and adhesion.

51. The film according to claim 46, wherein the substrate is at least one of an architectural structure, glass, metal, wood, plastic, concrete, vinyl, ceramic material and a coating layer applied on such a substrate.
